(19) United States
(12) Patent Application Publication
(10) Pub. No.: US 2012/0111210 A1
(43) Pub. Date: May 10, 2012

(54) INK CUP

(75) Inventor: Bradley C. Tutmark, Aloha, OR (US)

(73) Assignee: Nike Inc., Beaverton, OR (US)

(21) Appl. No.: 12/943,158

(22) Filed: Nov. 10, 2010

(51) Int. Cl. B41F 31/02

(52) U.S. Cl. 101/364

(57) ABSTRACT

A pad printing system for applying ink to an object includes an ink-vessel including a pressure plate; a shaft; and an ink-releasable member. The pressure plate moves linearly along the shaft based on a rotational force applied to the plate. The pad printing system may include a mounting portion; an ink-vessel for being mounted in the mounting portion. The ink-vessel includes a cavity having a ink-releasable member and a pressure plate for engaging the ink-releasable member. The pressure plate is positionable at one of a plurality of predetermined heights within the cavity. The pressure plate may be configured for resiliently biased movement between the predetermined heights.

### FIELD OF THE INVENTION

The present invention relates to pad printing systems, more particularly, to pad printer ink cup apparatuses.

### BACKGROUND

Pad printing is a common method for printing images on curved or other non-flat surfaces such as spherical, conical, cylindrical and other curved objects. Pad printing systems utilize a deformable pad that receives images from a flat printing plate and transfers the images to the curved surface that is to be printed. Typically, an inverted cup containing a quantity of printing ink is used to apply the ink to the printing plate. To apply a new coating of ink to the printing plate, the ink cup and printing plate are moved relative to each other following each ink transfer operation.

There is an increasing demand, particularly in the golf ball industry, for printing customized, multiple color images on curved objects. However, there are several significant problems with conventional pad printing techniques used to print multiple color images on an object.

It often can take several weeks to set-up a conventional multicolor pad printing system to run a particular image. Moreover, because the multiple ink dispensing cups must be cleaned and then refilled after each print run, often resulting in ink spills, these multicolor pad printing systems also waste a significant amount of printing ink.

In order to change ink in a pad-printer ink cup, it is necessary, after removing the cup, to pour the ink out and wipe out the excess material. This is a time consuming process, especially when dealing with frequent color changes, e.g. when creating customized markings on golf balls or any other article or part.

### SUMMARY OF THE INVENTION

The inventive aspects pertain to a pad printing system for applying ink to a curved object. In one aspect, a pad printing system for applying ink to an object includes an ink-vessel including a pressure plate and a shaft, and an ink-releasable member. The pressure plate moves linearly along the shaft based on a rotational force applied to the plate to compress and decompress the ink-releasable member.

In one aspect, an ink-vessel includes a cavity having an ink-releasable member and a pressure plate for engaging the ink-releasable member. The pressure plate is positionable at one of a plurality of predetermined heights within the cavity, and the pressure plate is configured for movement (e.g., resiliently biased movement or other movement) between the predetermined heights.

In one aspect, the pressure plate may include a plurality of apertures for enabling flow of ink. In another aspect, a biasing member for moving the pressure plate comprises a spring. In yet another aspect, the plate includes a plurality of grooves. The grooves may be radially disposed from a center of the plate in some example structures according to this invention. In other structures according to this invention, the grooves are disposed in at least one loop. In another aspect, a spring may be disposed around the shaft for providing resilient bias to the plate. In one aspect, the plate includes a plurality of notches disposed on a perimeter thereof. In yet another aspect, the plate comprises a frusto-conical shape.

In another aspect of this invention, the ink cup includes a stem coupled to a pressure plate, and a sponge material is used to absorb or release ink. The stem may include a biasing system or threaded engagement used for graduated control of the amount of ink placed on the pad or absorbed in the sponge.

The inventive aspects pertain to an ink-vessel designed to speed ink changes and allow pre-preparation of ink colors, and preservation of leftover ink.

### DESCRIPTION OF THE DRAWINGS

The foregoing Summary of the Invention, as well as the following Detailed Description of the Invention, will be better understood when read in conjunction with the accompanying drawings.

FIG. 1 is a schematic perspective view of a portion of a pad printing system showing an ink-vessel coupled to the system.

FIG. 2 is a schematic perspective view of a portion of a pad printing system showing a transfer pad configuration.

FIG. 3 is a perspective view of an ink-vessel for a pad printing system.

FIG. 4 is a perspective view of the ink-vessel of FIG. 3 showing an internal chamber.

FIG. 5 is a schematic view of an ink-vessel with ink releasing components in a first position.

FIG. 6 is a schematic view of an ink-vessel with ink releasing components in a second position.

FIG. 7 is a plan view of a pressure plate construction for use with the ink-vessel.

FIG. 8 is a plan view of an alternative pressure plate construction for use with the ink-vessel.

FIG. 9 is a plan view of an alternative pressure plate construction for use with the ink-vessel.

FIG. 10 is a plan view of an alternative pressure plate construction for use with the ink-vessel.

FIG. 11 is a plan view of an alternative pressure plate construction for use with the ink-vessel.

FIG. 12 is a plan view of an alternative pressure plate construction for use with the ink-vessel.

FIG. 13 is a schematic view of an alternative ink-vessel with ink releasing components.

FIG. 14 is a schematic view of an alternative ink-vessel with ink releasing components.

FIG. 15 is a schematic view of an alternative pressure plate construction.

### DETAILED DESCRIPTION

In the following description of various example embodiments of this invention, reference is made to the accompanying drawings that depict illustrative arrangements in which the invention may be practiced. It is understood that other embodiments may be utilized and modifications may be made without departing from the scope of the present invention. Additionally, various terms used herein are defined below.

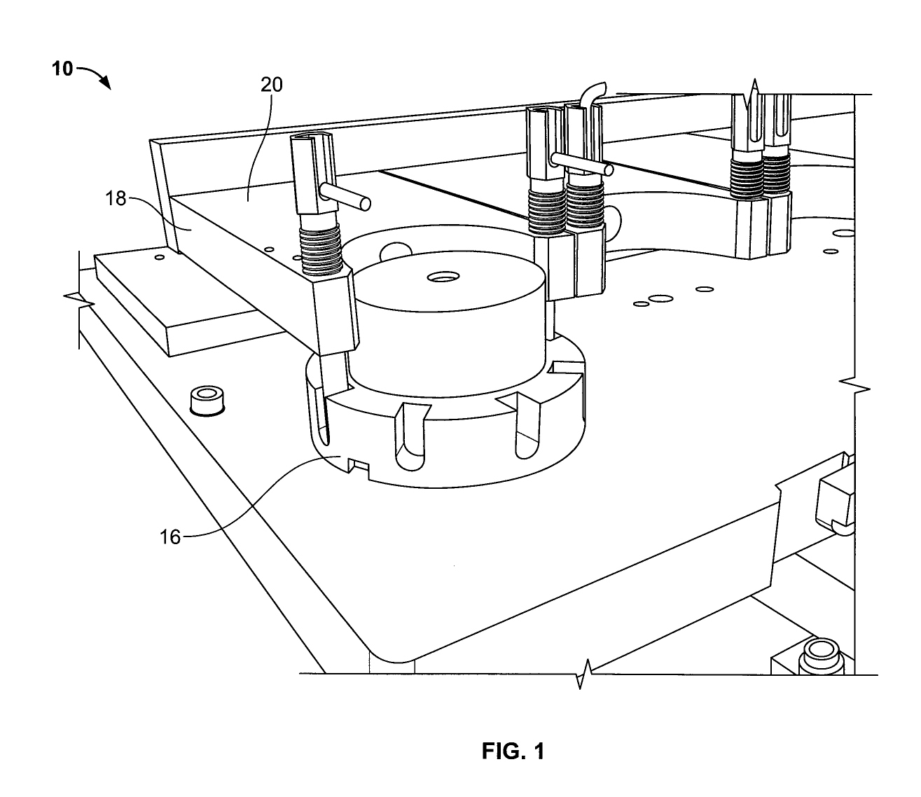

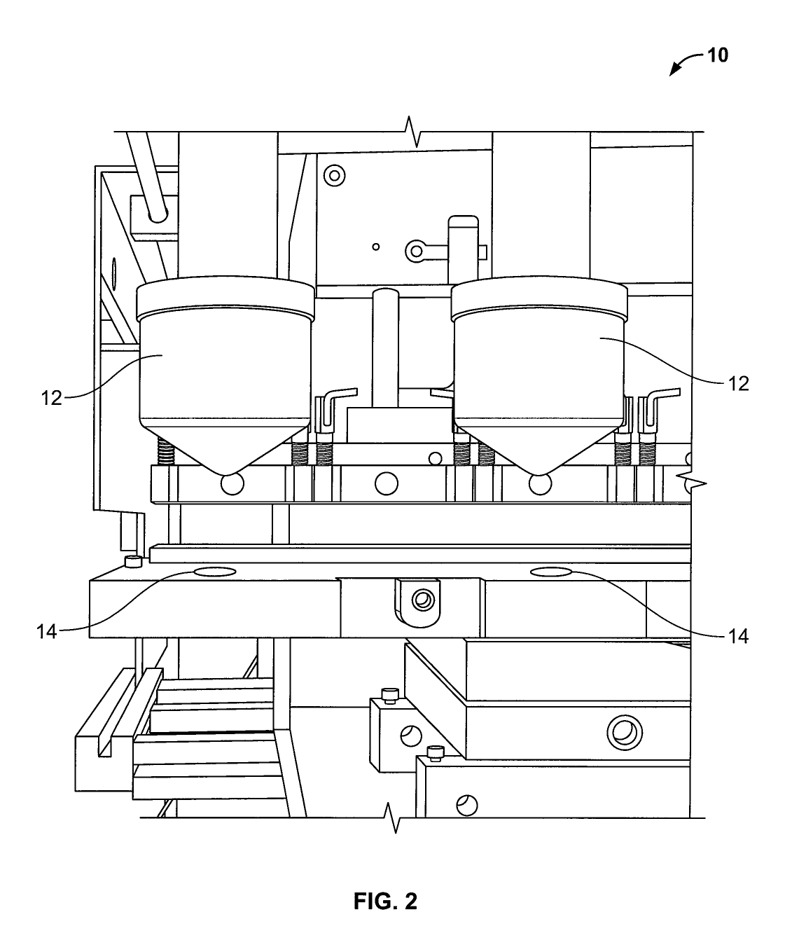

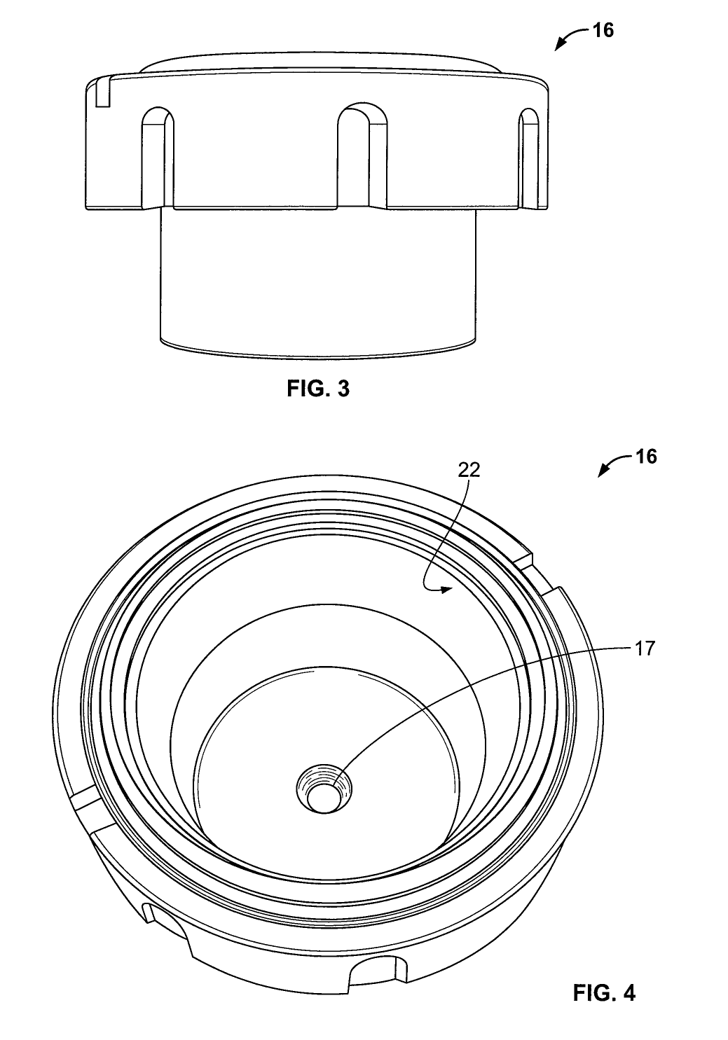

Referring to FIGS. 1-4, there is shown a representation of an example printing system 10 that may be adapted for printing images on non-flat surfaces such as those presented by spherical (e.g., golf balls), conical, cylindrical and other curved objects or parts. In a general operation, an ink-vessel 16 (e.g., ink cup) is mounted on a rack 18 and retained by a mounting system 20. Ink from the vessel 16 is provided to a printing plate (not shown). The printing plate includes an etched image. The cup 16 is slides over the top of the etched plate covering the image. The printing plate slides towards the transfer pad 12 in which the tip of the transfer pad 12 abuts to obtain an image to be printed on a golf ball 14. The printing plate slides back. The transfer pad 12 performs an image transfer operation by moving downwardly to the golf ball 14 and contacts the surface of the ball. Transfer pad 12 moves away from the golf ball 14 thereby leaving the image on ball. As shown in FIG. 4, the base of the ink-vessel 16 may include a threaded portion 17 to retain a shaft or stem (not shown for clarity). While the system 10 is described in connection with printing images on curved surfaces, it will be readily appreciated that the system 10 is equally applicable to printing on any type of surface including, for example, flat surfaces.

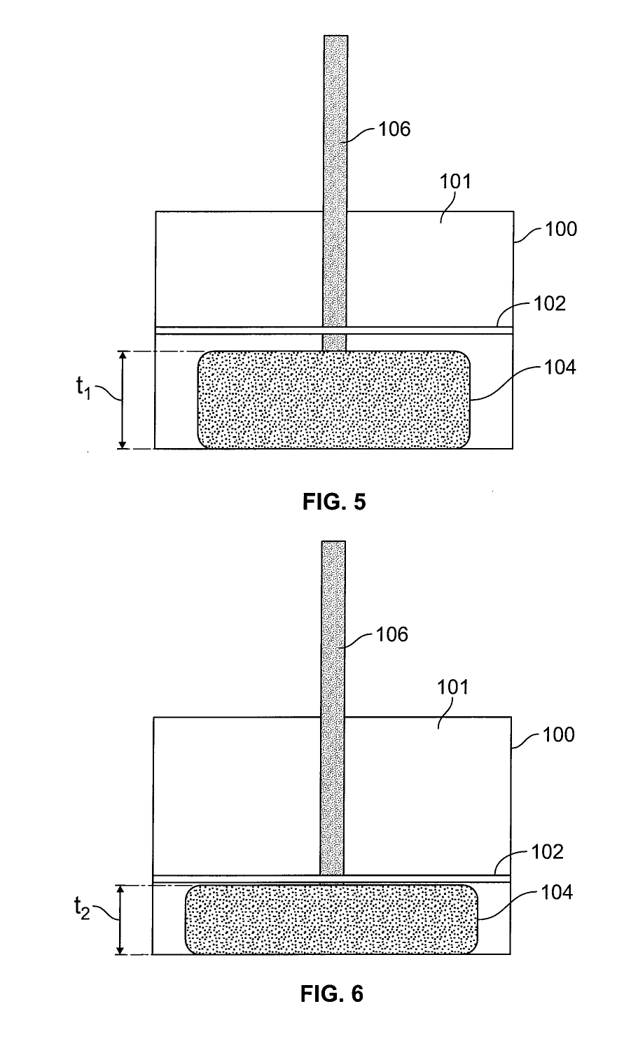

In one construction referring to FIGS. 5 and 6, a pad printing system for applying ink to the golf ball includes an ink-vessel 100 with a chamber 101 configured to retain an ink-releasable member or porous material 104, such as a sponge, polyurethane foam, melamine-material, other open cell foam, felt, fabric, porous plastic, etc., for storing a predetermined quantity of ink. A pressure plate 102 is provided for engaging the ink-releasable member 104. A compression mechanism, e.g. a perforated or non-perforated plate 102 with a tightening screw or clamp, will force the prepared ink out of the ink-releasable member 104 so that it can be applied to the printing plate. The pressure plate 102 is positionable at one of a plurality of predetermined heights within the void of the ink-vessel 100 to enable a graduated release of ink into a deployment chamber 101 of the ink-vessel 100. The deployment chamber 101 is that cavity area above the plate 102. Prior to compression, the ink-releasable member 104 has a first thickness of t1 (see FIG. 5). During compression, as shown in FIG. 6, the ink-releaseable member 104 has a second thickness denoted as t2. During the compression operation, thickness t2 is less than thickness t1.

When the printing operation is finished the pressure plate 102 can be loosened and the leftover ink can be re-absorbed into the ink-releaseable member 104 and the member 104 may then be placed into a sealed container of the proper size for storage of leftover ink. As discussed in the foregoing, the shaft 106 may include a biasing system or be configured for threaded engagement for graduated control of the amount of ink released or absorbed in the ink-releaseable member 104.

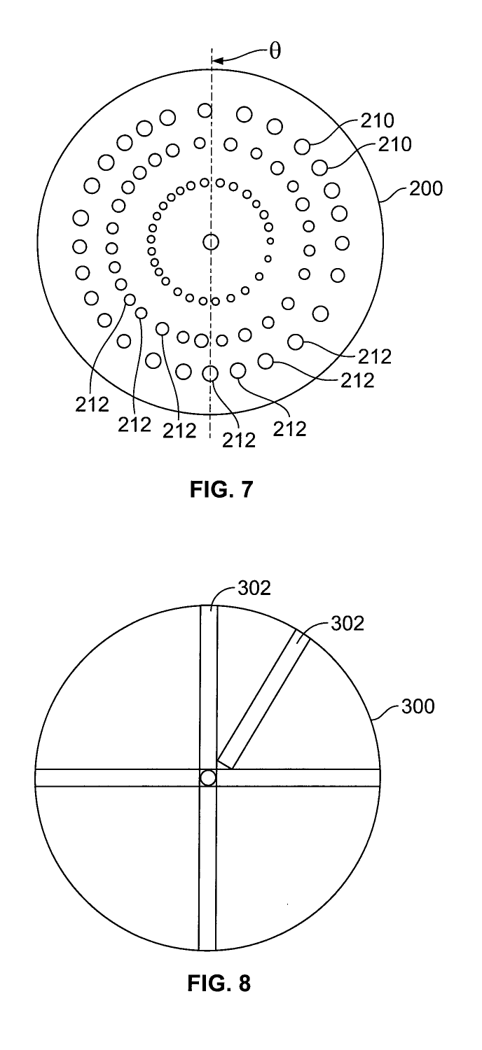

Referring to FIG. 7, an example pressure plate construction 200 is illustrated. This example pressure plate 200 includes a plurality of apertures 210 sized for enabling ink released from the ink-releaseable member 104 to flow into the deployment portion 101 of the ink vessel or cup 100. The released ink is delivered to the printing plate for subsequent absorption of a printing image with ink by transfer pad 12. The apertures 210 can take on a variety shapes, such as circular, triangular, square, rectangular, and oval. Nevertheless, the apertures 210 can be provided in other shapes and sizes. In another aspect, the apertures 210 can be provided in a variety of patterns and configurations. The apertures 210 can be provided in a uniform density pattern on the plate 200. The apertures 210 may be disposed in concentric rings, rows or loops 212 at spaced radial distances from the center of the plate 200. This configuration encourages ink to more uniformly flow from the ink-releasable member 104 under compressive pressure into the deployment chamber 101 of the ink-vessel 100. In one construction, apertures 210 on adjacent loops 212 may be radially aligned. For example, adjacent loops 212 have apertures 210 that are directly behind each other. A first aperture is said herein to be “directly behind” a second aperture when it is located within the lateral bounds of the second aperture extending in a radial direction. In an alternative arrangement, the adjacent loops 212 can be in a staggered arrangement where the apertures 210 are not directly radially behind another aperture. Nonetheless, the apertures 210 could be arranged randomly or in a myriad of different ordered patterns.

In another example construction shown in FIG. 8, a pressure plate 300 may be configured to have flow grooves or channel recesses 302 that are provided to enable improved collection of released ink on the plate 300. In one construction, the grooves 302 may be radially disposed on the plate 300. In such a construction, the grooves 302 pattern may resemble a hub-spoke configuration. The grooves 302 may be provided at uniform incremental degrees around the plate 300. In some example constructions, the incremental degree spacing of the grooves 302 may range from 10 degrees to 180 degrees. For example, the grooves 302 could be provided at every 10 degrees thereby providing 36 grooves. In another example, the grooves 302 could be provided at every 45 degrees thereby providing eight grooves. In yet another example, the increment could be 180 degrees to provide two grooves 302. The number of grooves 302 (and/or their dimensions, spacing, relative positioning, etc.) provided on the plate 300 can be configured based on various factors, such as the desired amount of flow velocity of the ink into the deployment chamber 101, the viscosity of the ink, the anticipated volume of the ink to be dispensed, etc. Also, the groove configurations (e.g., number, sizes, spacing, arrangements, etc.) may be tuned based on the compressive pressure to be applied to the ink-releasable member 104.

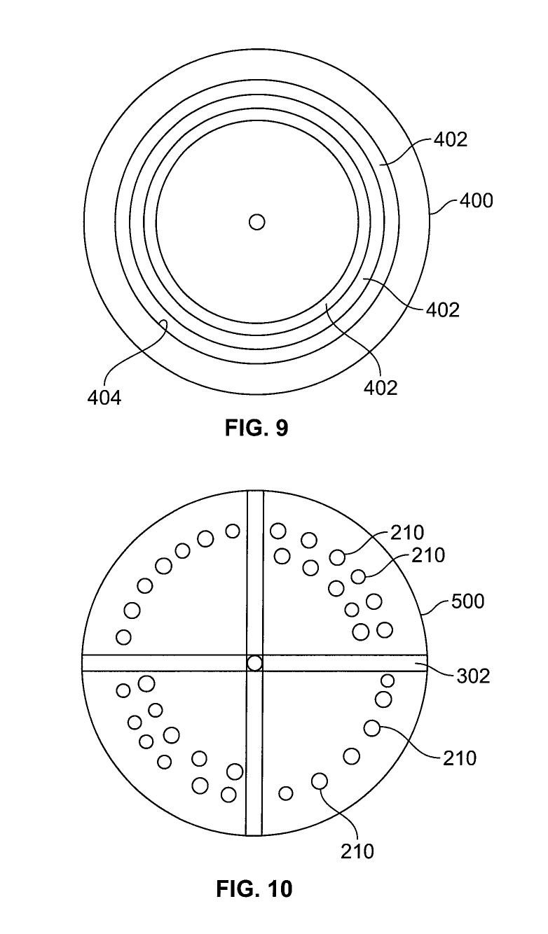

In another example construction shown in FIG. 9, a pressure plate 400 includes grooves 402 provided in concentric rings 404 or non-concentric rings spaced from the center of the plate 400. In the concentric ring construction, the rings 404 can be regularly spaced from the center of the plate 400 to a predetermined total radial distance. The number of rings may be selected based on various factors, such as the diameter of the plate 400, the amount of desired ink flow, the ink viscosity, etc.

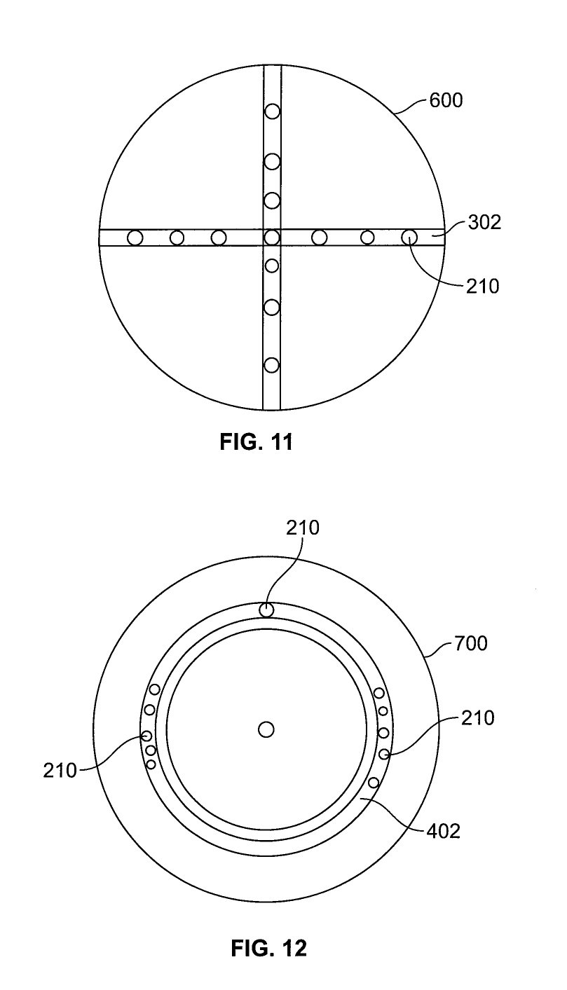

In the construction of the grooves in the ring configuration or the hub-spoke configuration, apertures may be disposed within the grooves. Referring to the alternative aperture-groove constructions shown in FIGS. 10 through 12, ink can be released from the ink-releasable member 104 and the released ink can be readily collected for deployment when pressure is applied to the plate. The alternative pressure plates 500, 600, and 700 include combinations of the features of pressure plates 200, 300, and 400. In operation, when excess ink has been dispensed by the ink-releasable member 104 and needs to be reabsorbed by this member 104, the grooves act as collection vessels to channel the ink back to the ink-releasable member 104 underneath the plate 400.

The pressure plate 102 through 700 may have a number of constructions for facilitating ink release and subsequent collection of the ink by the ink-releasable member 104. The center of the plate may include a threaded bore for threaded engagement with shaft 106 coupled to the ink-vessel 100 (see FIGS. 5 and 6). In one construction, the pressure plate may be a flat plate. In this construction, the plate moves linearly with respect to the shaft 106 and sidewalls of the ink-vessel 100 responsive to a rotational movement. For example, clockwise rotation of the plate will linearly move the plate in the direction toward the ink-releasable member 104. The ink-releasable member 104 starts to compress (e.g., the initial thickness becomes reduced) as the plate abuts the ink-releasable member 104 and continues to traverse against the ink-releasable member 104. Likewise, counter-clockwise rotation of the plate enables it to move linearly away from the ink-releasable member 104. This action decompresses the ink-releasable member 104 thereby allowing the ink-releasable member 104 to expand and reabsorb leftover ink.

In another construction shown in FIG. 14, the pressure plate 800 may be provided in a frusto-conical shape. In this construction, the frusto-conical shape provides for a collection cone. The angle THETA of the cone 800 can be adjusted by one of skill in the art. The center of the plate 800 includes a threaded bore for threaded engagement with shaft 106 coupled to the ink-vessel 100. In this construction, the plate 800 moves linearly with respect to the shaft and sidewalls of the ink cup 100 responsive to a rotational movement. For example, clockwise rotation of the plate 800 will linearly move the plate 800 in the direction toward the ink-releasable member 104. The ink-releasable member 104 starts to compress (e.g., the initial thickness becomes reduced) as the plate 800 abuts the ink-releasable member 104 and continues to traverse against the ink-releasable member 104. Likewise, counter-clockwise rotation of the plate 800 enables it to move linearly away from the ink-releasable member 104. This action decompresses the ink-releasable member 104 thereby allowing the ink-releasable member 104 to expand and reabsorb leftover ink. The frusto-conical shape of the pressure plate 800 causes variable radially compression pressure from the center of the ink-releasable member 104 to the perimeter. This configuration enables ink to be released and filled into the deployment chamber 101 quickly as the plate 800 engages the ink-releasable member 104.

In an alternative construction shown in FIGS. 5-13, the pressure plate 102, 200, 300, 400, 500, 600, 700 and 800 does not necessarily have a threaded bore. The center portion of the plate can lack threads so that the plate slides along the shaft 106. In this construction, a compression member 900 may have a threaded bore and may abut the plate. For example, the compression member 900 may be wing-nut configuration. Clockwise rotation of the compression member 900 will linearly move the plate in the direction toward the ink-releasable member 104. Likewise, counter-clockwise rotation of the compression member 900 enables the plate to move linearly away from the ink-releasable member 104. This action decompresses the ink-releasable member 104 thereby allowing the ink-releasable member 104 to expand and reabsorb leftover ink.

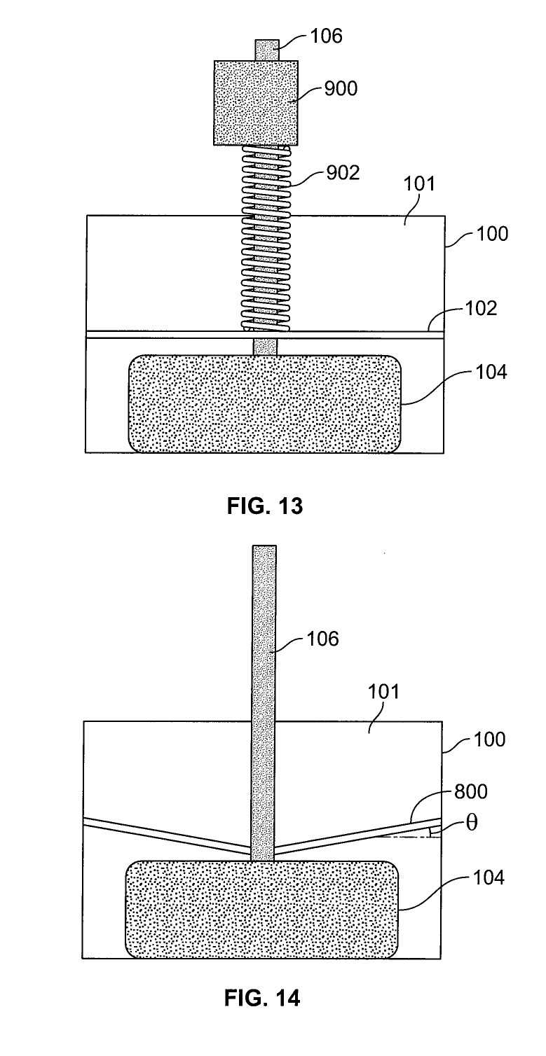

With continued reference to FIG. 13, the pressure plate 102 may be configured for resiliently biased movement between the predetermined heights. In an alternative construction, the compression member 900 may be augmented with a biasing member 902 to provide increased compressive force against the pressure plate. The biasing member 902 can be provided in the form of a coil spring disposed around the shaft 106. Nevertheless, the biasing member 902 could be a leaf spring construction. The distal end of the coil spring 902 abuts the plate and the proximal end of the coil spring 902 abuts the compression member 900, such as wing-nut. The coil spring 902 can have a selected spring constant (K) to enable different compression profiles to compress the ink-releasable member 104. In this construction, the pressure plate can readily slide along the shaft 106. Clockwise rotation of the compression member 900 will compress the spring 902 to linearly move the plate in the direction toward the ink-releasable member 104. In this way, biasing member (e.g., spring 902) provides increased compressive pressure for each turn of the compression member 900. Additionally, the spring constant can be tuned to the compression characteristic of the ink-releasable member 104. It should be noted that counter-clockwise rotation of the compression member 900 enables the spring 902 to decompress so that the plate to moves linearly away from the ink-releasable member 104. This action decompresses the ink-releasable member 104 thereby allowing the ink-releasable member 104 to expand and reabsorb leftover ink.

If desired, a sealing member, such as an O-ring seal, may be provided in the annular space between plate and ink-vessel sidewall 22, for example, a perimeter of O-ring seal may contact sidewall 22 (see FIG. 4). This O-ring seal provides a wiping action against the peripheral surface of the sidewall 22. The O-ring seal may be made of any known, soft and resiliently pliable material, such as, soft plastic or rubber.

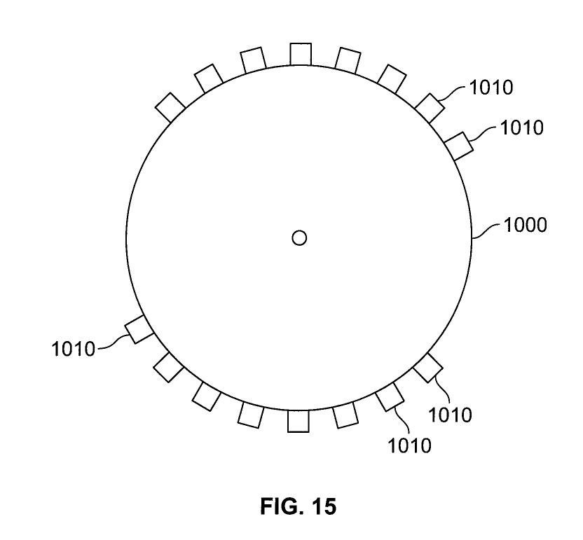

In one construction shown in FIG. 15, the pressure plate 1000 may include perimeter disposed notches 1010 configured to enable flow of ink from the ink-releasable member 104. The notches may be provided at uniform incremental degrees around the plate. In some constructions, the incremental degree of the notches may range from 5 degrees to 180 degrees. For example, the notches could be provided at every 5 degrees thereby providing 72 notches around the perimeter of the plate. In another example, the notches could be provided at every 45 degrees thereby providing eight notches. In yet another example, the radial degree increment could be 180 degrees to provide two notches on the perimeter of the plate.

While the various features of system 10 work together to achieve the advantages previously described, it is recognized that individual features and sub-combinations of these features can be used to obtain some of the aforementioned advantages without the necessity to adopt all of these features. The present invention is disclosed above and in the accompanying drawings with reference to a variety of embodiments. The purpose served by disclosure of the embodiments, however, is to provide an example of the various aspects embodied in the invention, not to limit the scope of the invention. One skilled in the art will recognize that numerous variations and modifications may be made to the embodiments without departing from the scope of the present invention, as defined by the appended claims.

1. An ink vessel for a pad printing system, comprising:
a pressure plate for engaging an ink-releasable member, a first cavity and second cavity being separated by the pressure plate, the ink-releasable member being disposed in the second cavity and, the pressure plate being positionable at a plurality of different heights along a shaft and configured for movement between a first height and a second height to engage the ink-releasable member.

2. The ink vessel according to claim 1, wherein the pressure plate includes a plurality of apertures for enabling flow of ink between the first and second cavities.

3. The ink vessel according to claim 2, wherein the apertures are provided in at least one loop.

4. The ink vessel according to claim 1, wherein the pressure plate includes a plurality of grooves.

5. The ink vessel according to claim 4, wherein the grooves are radially disposed from a center of the pressure plate.

6. The ink vessel according to claim 5, wherein the pressure plate includes a plurality of apertures.

7. The ink vessel according to claim 4, wherein the grooves are disposed in at least one loop.

8. The ink vessel according to claim 7, wherein the pressure plate includes a plurality of apertures.

9. The ink vessel according to claim 1, further comprising a spring disposed around the shaft for providing resilient bias.

10. The ink vessel according to claim 1, wherein the pressure plate includes a plurality of notches disposed on a perimeter thereof.

11. The ink vessel according to claim 1, wherein the pressure plate comprises a frusto-conical shape.

12. An ink-vessel for a pad printing system for applying ink to an object, comprising: a pressure plate; a shaft; and an ink-releasable member, wherein the pressure plate moves based on a rotational force applied to the plate to compress and decompress the ink-releasable member.

13. The ink vessel according to claim 12, wherein the pressure plate includes a plurality of apertures for enabling flow of ink.

14. The ink vessel according to claim 12, wherein the plate includes a plurality of grooves.

15. The ink vessel according to claim 14, wherein the grooves are radially disposed from a center of the plate.

16. The ink vessel according to claim 15, wherein the pressure plate includes a plurality of apertures.

17. The ink vessel according to claim 16, wherein the apertures are disposed in at least one loop.

18. The ink vessel according to claim 12, wherein the pressure plate includes a plurality of apertures disposed in at least one groove.

19. The ink vessel according to claim 18, wherein the at least one groove is radially disposed from a center of the pressure plate.

20. The ink vessel according to claim 12, wherein the pressure plate comprises a frusto-conical shape.
